(19) United States
(12) Patent Application Publication
(10) Pub. No.: US 2003/0072094 A1
(43) Pub. Date: Apr. 17, 2003

(54) Bus mount to hold mirror supporting shaft

(75) Inventor: Benjamin Englander, Jamaica, NY (US)

Correspondence Address: OSTROLENK FABER GERB & SOFFEN, 1180 AVENUE OF THE AMERICAS, NEW YORK, NY, 100368403

(73) Assignee: ROSCO, INC.

(21) Appl. No.: 10/299,883

(22) Filed: Nov. 19, 2002

Related U.S. Application Data
(63) Continuation of application No. 09/566,524, filed on May 8, 2000, now abandoned.
(63) Continuation of application No. 09/488,579, filed on Jan. 21, 2000, now abandoned.
(60) Provisional application No. 60/331,703, filed on Nov. 19, 2001.

(51) Int. Cl. G02B 7/182

(52) U.S. Cl. 359/871; 359/838; 359/872

(57) ABSTRACT

A mount assembly for securing the staff or pole of a mirror to a vehicle, including a plastic, integrally molded mount body which defines an interior chamber with a peripherally extending edge shaped to mate and fit a base piece which itself is shaped to fit the vehicle surface to which the mount body is to be secured. A clamping plate is disposed within the interior chamber and several screws, accessible through the exterior of the mount body, engage the mounting plate and are capable of being tightened to pull the clamping plate, and thus secure between the interior surface of the mount body and the clamping plate, the staff which holds the mirror element.

### RELATED APPLICATION

This Application is a continuation of U.S. Provisional Application Serial No. 60/138,623 filed Jun. 11, 1999, and entitled “BUS MOUNT TO HOLD MIRROR SUPPORTING SHAFT”; U.S. application Ser. No. 09/566,524 and is further related to U.S. application Ser. No. 29/109,246. The contents of the foregoing documents are incorporated by reference herein.

### BACKGROUND OF THE INVENTION

1. Field of the Invention

The present invention relates to a mirror mount for vehicles and more particularly to a mount attachable to the body of a vehicle and adapted to securely hold the pole or staff of an automotive mirror.

2. Related Art

Motor vehicles, and in particular larger vehicles such as buses, trucks and the like, require an array of mirrors mounted on exterior surfaces of such vehicles in order to improve the visibility and field of view of the driver in and around the vehicle. Typically, an automotive mirror element has attached to it a staff or pole which is secured within a mount which is in turn attached to the body of the vehicle.

The present invention concerns itself with the mount per se and specifically with a mount of the type which can be attached to the body of the vehicle, for example to the fenders, and also, if desired, to the back of the mirror element to serve the mirror staff therein.

Mirror mounts of the above type are described in the present Assignee's previously issued U.S. Pat. No. 5,576,899, the contents of which are incorporated by reference herein. In addition, mirror mounts for vehicles have been described in several issued patents, including U.S. Pat. Nos. 2,969,715, 3,592,532, 4,165,156, 4,500,063, 5,316,257 and 5,106,049.

The mount described in the aforementioned U.S. Pat. No. 4,500,063; the '257 patent and the '049 patent are comprised of two pieces including a base and a cover member. The base member is formed to match the contour of the body i.e., fender, if a vehicle and comprises apertures in which self-tapping screws are screwed in order to tightly secure the base member to the vehicle. In certain embodiments of the prior are, there are provided special struts that are similarly shaped to complement the contour of the vehicle fender portion to which the base is fastened by screws and the like. In the present Assignee's aforementioned U.S. Pat. No. 5,576,899 mount construction, rather than providing a base and cover pair, a single-piece mount is provided which has a periphery that lies against the body of the vehicle and which defines internally a space or a chamber in which the pole or staff of the automotive mirror is received. Inside the chamber, a clamping member fastens the pole or the staff to a specially defined nestling region against which the pole is tightly engaged.

Prior art FIG. 1 herein shows the mount 10 of U.S. Pat. No. 5,576,899 fastened to the front curved portion 12 of the fender 14 of a vehicle 16. The vehicle 16 may be a school bus, truck, van, automobile, or indeed any vehicle.

The mount itself consists (see FIG. 2) of a mount body 20 and a clamping plate 22 which together firmly hold and secure therebetween one end of a mirror pole 24 (FIG. 1) which holds at its outer distal end 26 a mirror element 28.

The mirror body 20 is attachable to the vehicle 16 by several metal screws 30 located around the periphery of the mount body 20. These screws 30 are insertable through screw openings 32 as shown in FIGS. 1 and 2.

The mount body 20 defines an interior chamber which is circumscribed and defined by peripheral side edge 36, the peripheral side edge 36 being shaped and configured to precisely fit and mate with the vehicle surface such as the fender surface of the vehicle 16 to which the mount body 20 is to be secured. At the top, the mirror body 20 has a sloping panel 38 defining an opening 40 through which the mirror pole 24 is insertable into the interior chamber in which the pole 24 is eventually clamped between the inner surface of the body 20 and the clamping plate 22.

Of particular relevance to the present discussion are the screw openings 32 which are formed in a slightly thickened portion of the body 20 and through which screws 30 are insertable in order to tightly fasten the mount body to the vehicle. The fastening of the device shown in FIGS. 1 and 2 to the vehicle leaves the surface of the body 20 close to the fender body as shown in FIG. 3. The head of the screw 30 is virtually against the body of the vehicle with only a small thickened portion of the body connected thereto. This leaves no challenge to reliable and tight securing of the body to the vehicle.

Certain vehicle bodies have fender locations in which the surface of the fender is bent sharply, as much as 90° to the point where the mount body 20 needs to be connected. Such vehicle surfaces provide special challenges for being able to secure a mount of the type disclosed in the aforementioned U.S. Pat. No. 5,576,899 patent to the body of the vehicle.

### SUMMARY OF THE INVENTION

Accordingly, the general objective of the present invention is to provide a substantially improved mirror mount which can be mounted to substantially bent vehicle surfaces.

It is a further object of the present invention to provide a mirror mount which is sturdier, less expensive and reliably connectable to a vehicle body.

The foregoing and other objects of the present invention are realized by a mirror mount comprising a single-piece, integrated mount body which defines an interior chamber in which the mirror pole is insertable through a top opening in the mount body. The mount body has a peripheral edge which is shaped to precisely fit the vehicle surface to which the mount body is to be secured, for example, the fender surface of a vehicle, or another portion of the vehicle.

Within the interior chamber of the mount body is a clamping plate, preferably metallic, that is held by several screws which are accessible from the front of the mount body. The screws are designed to be tightened, to thereby pull the clamping plate toward the interior surface of the mirror mount in a manner which enables the clamping plate to be coupled tightly against the mirror pole and thus secure it in place.

The interior chamber of the mount body of the invention defines a comparatively large space which is defined by a vertically oriented first surface, which defines within the interior chamber a nestling region for the pole or staff of an automotive mirror against which the clamping plate is drawn. A generally horizontally extending ceiling portion extends from the first surface toward the vehicle and left and right panels create in the mount body the aforementioned interior chamber. Since mounting screws which are necessary to connect the mounting bracket to the vehicle must be threaded from the aforementioned substantially vertical and the head portion of the mount body, there are provided in a novel manner, long, extending barrels which are formed inside the interior space which extends at angles relative to the first and second surfaces. These screw barrels are connected by a web or another fastening connection to the left and right panels to provide a channel for the screws to connect the mount body to the vehicle.

The present invention provides a mirror mount body formed as an integrally molded plastic element, having exterior and interior surfaces, the interior surface defining an interior chamber and terminating at a peripheral edge shaped to mate with an external surface of a vehicle body to which the mount body is attachable, the interior surface of the mount faces the external surface of the vehicle body, the interior chamber being circumscribed such that the interior chamber is substantially closed off when the mount body is mounted to the external surface of the vehicle body, the mount body comprising a pair of panels which converge toward one another and define a nestling region for a mirror pole; securing apparatus for fixedly securing the mount body in contact with the external surface of the vehicle body including a plurality of elongated barrels extending from the interior surface of the mount body towards the peripheral edge, each barrel including an aperture extending therethrough and communicating, at one end, with the exterior surface of the mount body; a plurality of elongated fasteners, one extending through each aperture, for fixedly coupling the mount body to the external surface of the vehicle body; a clamping plate fully disposed within the interior chamber; and a tightening element accessible and operable from an exterior surface of the mount body which engages the clamping plate and pulls the same toward the interior surface.

Other features and advantages of the present invention will become apparent from the following description of the invention which refers to the accompanying drawings.

### BRIEF DESCRIPTION OF THE DRAWING

For the purpose of illustrating the invention, there is shown in the drawing a form which is presently preferred, it being understood, however, that the invention is not limited to the precise arrangement and instrumentality shown.

FIG. 1 is a perspective view showing a prior art mirror mount secured to the corner, at the left fender of a bus.

FIG. 2 is an exploded view of a prior art mirror mount showing the conventional clamping plate and interior space and the manner of securing the staff of a mirror.

FIG. 3 shows a prior art mode of connecting the mount body to the fender of a vehicle.

FIG. 4 is an exterior perspective of the novel mirror mount of the present invention.

FIG. 5 is a perspective of the interior of the novel mirror mount of the present invention.

FIG. 6 is a cross section through the mirror mount of FIG. 5 seen along the lines A-A.

FIG. 7 is a further embodiment of a mirror mount to hold a mirror supporting shaft.

FIG. 8 is an exploded view of the mount of FIG. 7, disassembled to show its two main constituent parts.

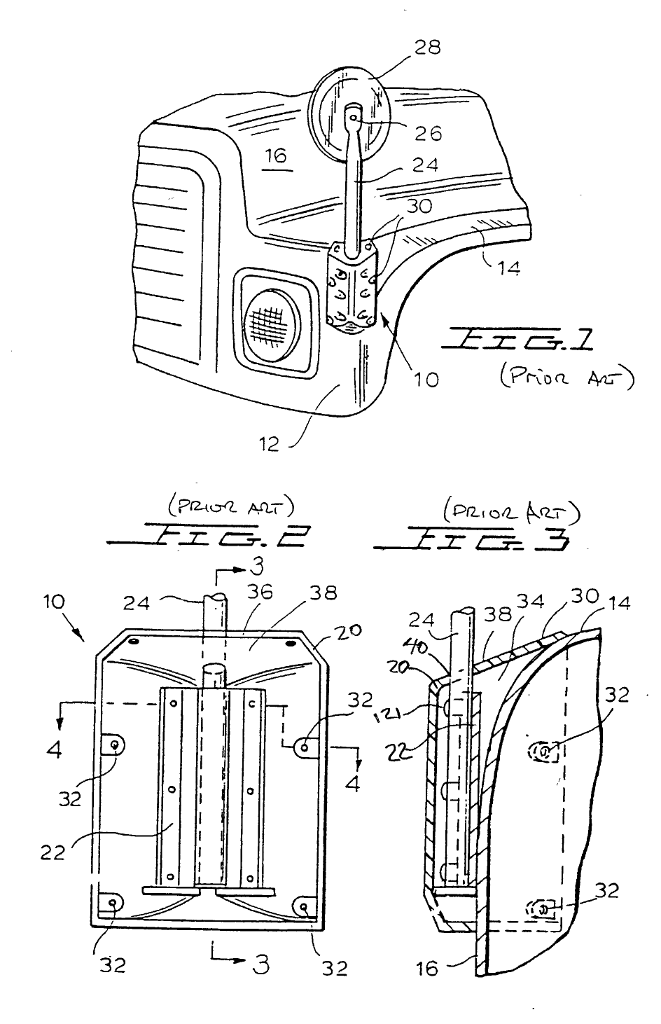

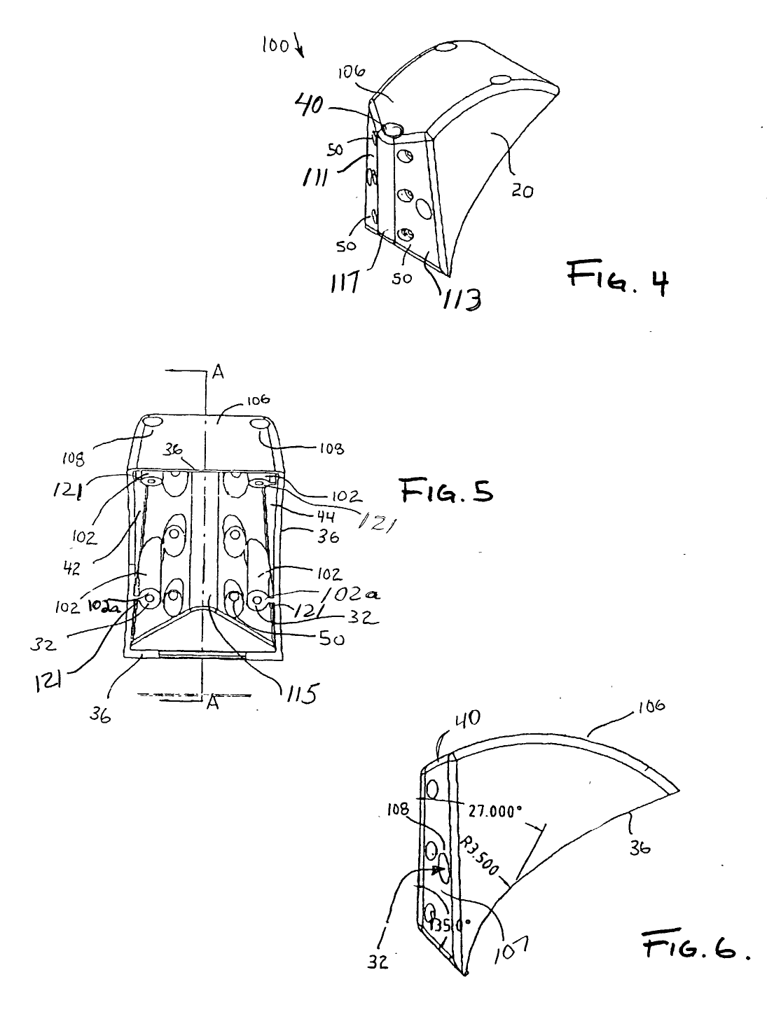

### DETAILED DESCRIPTION OF THE INVENTION

Referring now to the drawing wherein like numerals indicate like elements, there is shown in FIG. 4 a perspective view of the mirror mount 100 of the present invention. The mount body 20 of the mirror mount 100 includes a plurality, preferably six, access holes 50 for receiving screws which secure a clamping plate (not shown) to the mount body 20. As discussed above, the clamping plate fixedly couples the mirror pole 24 to the mount body 20 when the screws are tightened through the access holes 50 and into the clamping plate.

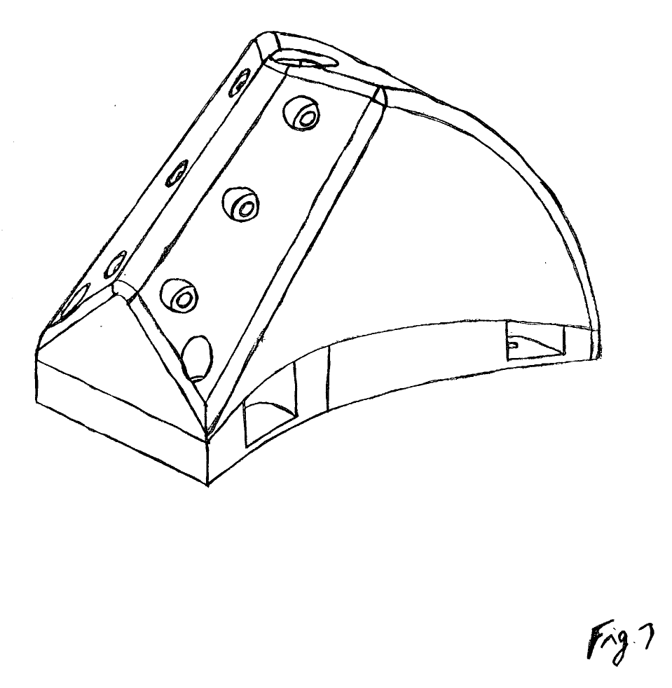

With reference to FIG. 5, critical to the invention are a plurality of barrels 102 disposed within the mount body 20 towards a peripheral edge 36 thereof. Most preferably, the barrels 102 are disposed at side walls 42, 44 of the mount body 20 and include a web 104 for coupling the barrel 102 to a respective side wall 42, 44, thereby strengthening the barrel 102 and side wall 42, 44 of the mount body 20.

Each barrel 102 preferably includes an aperture 32 extending therethrough and communicating with an exterior surface 106 (FIG. 4) of the mount body 20 and a surface of the vehicle to which the mount body is connected. The apertures 32 provide a path for substantially elongated and lengthy screws to extend from the surface 106 of the mount body 20 toward and into the vehicle surface to which the mount body 20 is attached.

The elongated barrels 102 each include one end integrally communicating with the interior surface of the mount body 20 and a distal end proximate the peripheral edge 36. Each elongated barrel 102 preferably includes an outer peripheral surface between the one end integrally communicating with the interior surface of the mount body 20 and the distal end. At least a portion of the peripheral surface of each barrel 102 is preferably coupled to the interior surface of the mount body 20.

Preferably, the outer peripheral surface of each barrel 102 is coupled to the side walls 42, 44 via a respective web(s). It is most preferred that each such web member extends substantially the entire length of the respective barrels 102. Advantageously, the webs permit extensions from about 0.5 to 2.0 inches when counter-sinks 108 are employed. Longer barrels 102 may be employed when counter-sinks 108 are not utilized or when relatively shallow counter sinks 108 are employed.

With reference to FIG. 6 which illustrates a cross sectional view of the mount body 20 taken through section A-A of FIG. 5, one skilled in the art can appreciate that the apertures 32 extending through barrels 102 are substantially long because they must extend from the rear surface 106 of the mount body 20 to the vehicle surface. It is most preferred that each aperture 32 include a counter-sink region 108 which receives the head of a screw or bolt that is passed through aperture 32 such that the head falls below the rear surface 106 for a pleasing aesthetic appearance.

Those skilled in the art will appreciate that the profile of the peripheral edge 36 of the mounting body 20 is particularly suited for the Navistar (NAV) bus exterior and that the barrels 102 provide a longitudinal extension channel (via aperture 32) such that a rigid, sturdy and secure connection between the mount body 20 and the surface of the bus (preferably a NAV bus) is obtained.

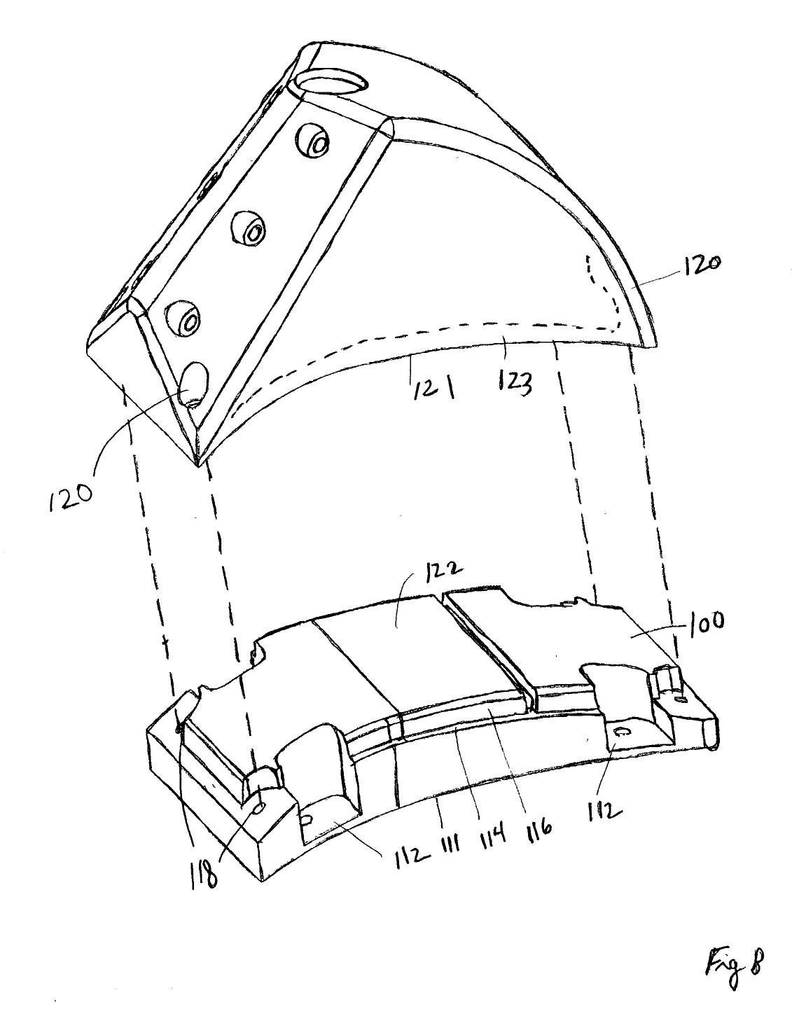

With reference to FIG. 7, the differently constructed mount is composed of two parts, as shown in FIG. 8, including a base 100 and a cover 120. The base 100 has a bottom contour 111 which is shaped to complimentarily match the shape of the vehicle to which the base 110 is intended to be mounted. The mounting of the base to the vehicle is by means of screws, bolts and the like, that pass through opening defined in screw wells 112, of which four are provided adjacent the four corners of the base 100. The base also has a ledge 114 defined by a base and an outwardly extending wall 116, extending peripherally around the base, on its four sides.

Preferably, the bottom 121 of the cover has a periphery 121 which complementarity matches the shape of the ledge 114, including (optionally), an inner flange 123 that circumscribes the opening in the cover 120 and which engages or is designed to abut the vertical portion 116 of the ledge of the base 100, so that when the cover 120 is fitted to the base 100 and affixed thereto by means of screws or bolts that engage the openings 118 at the four corners of the base, and in the screw wells of the cover 120, the cover 120 will hold firmly to the base and will not allow side to side and up and down movement relative to the base 120.

In other respects, the cover 120 serves the same functionality as heretofore described in holding a shaft against its inner surface by means of a plate that is drawn by screws that can be tightened from the outside, as heretofore described. Thus, a single cover 120 can be used with a large variety of different vehicle bodies, with only the base 100 requiring to be selected for, or adopted to the particular vehicle body shape.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A mirror mount assembly, comprising:
a base having a bottom contour that is shaped to complementarily match the shape of a vehicle to which the base is to be secured;
a mount body, formed as an integrally molded piece, having an interior surface facing and defining an interior chamber, and a periphery shaped to mate with an external surface of the base to which the mount body is attachable in a manner such that the interior surface of the mount faces the external surface of the base, the interior chamber being constructed so that when the mount body is mounted to the external surface of the base, the interior chamber is substantially closed off, the mount body comprising a pair of panels which converge toward one another and define a nestling region for a mirror pole;
a clamping plate fully disposed within the interior chamber and juxtaposed to the nestling region for the mirror pole; and
a fastening system, accessible and operable from an exterior surface of the mount body and constructed to engage the clamping plate and pull the clamping plate towards the nestling region to clamp a mirror pole between the clamping plate and the nestling region.

2. The assembly of claim 1, including a ledge defined on the base and the periphery of the mount body engaging and contacting the base at the ledge of the base.

3. The assembly of claim 1, including fasteners that mount the base to the vehicle.

4. The assembly of claim 1, including fasteners that secure the mount body to the base.

5. The assembly of claim 1, including a kit containing several bases that have bottom surfaces that match different vehicles and accompanied by at least one main body, whereby the main body can serve as a universal piece that fits different vehicles with only the base being required to be matched for a particular vehicle body shape.
